(19) United States
(12) Patent Application Publication
(10) Pub. No.: US 2011/0121663 A1
(43) Pub. Date: May 26, 2011

(54) Power supply interrupter (cellular device)

(76) Inventors: L.E. Pauli Coffey, Indianapolis, IN (US); Chris Allen Smock, Indianapolis, IN (US)

(21) Appl. No.: 12/925,717

(22) Filed: Oct. 28, 2010

Related U.S. Application Data
(60) Provisional application No. 61/262,959, filed on Nov. 20, 2009.

(51) Int. Cl. H01H 47/00

(52) U.S. Cl. 307/126

(57) ABSTRACT

This device, either applied as an aftermarket part to any cellular charging device or as an internal part of a newly designed “factory offered” cellular charging device, when unplugged from the battery operated cellular device, will automatically stop pulling power from the main power source to include but not limited to a wall mount power outlet, vehicle data port or secondary computer port, thereby eliminating the waste of electricity and precious resources.

### BACKGROUND OF THIS INVENTION

This invention is for the purpose of preventing the waste of electricity caused by cell phone chargers, and similar cellular charging devices, when not in use charging a phone, or other cellular communication device, but that are still plugged into a power supply [port] of any kind, including but not limited to a standard household power outlet, vehicle data port or computer port.

An example of such a cellular communication device is the LG remarq, [remarq], licensed by QualComm Inc. under various patents. This particular cellular communication device can be charged via a wall port charging device, vehicle port charging device or, with proper application, a computer charging port. At the point that the battery of the [remarq] is fully charged, this particular cellular device is removed for use or mobility reasons but the charging device often remains plugged in to the power supply port. Power will continue to pull from whichever power supply is being utilized. This unnecessary use of power has resulted in minor consequences such as a dead car battery and extended up to the enormous waste of residential and commercial electricity which affects all of modern civilization.

### SUMMARY OF THE INVENTION

According to a typical embodiment of the present invention, the power supply cut-off switch is fitted between the cellular device charging circuit and the external 110/115 VAC power source or [port]. Cabling will extend from the power supply cut-off switch to the activation switch located on the cellular device charging plug. Power for the supply cut-off switch and activation switch will be supplied from the same 110/115 VAC power source or computer port as the cellular device power supply.

### BRIEF DESCRIPTION OF THE DRAWINGS

Figure A: Is a schematic drawing of the entire system when used as an add-on configuration unit. In this configuration, a plug in wall box is used containing a relay with a 110 Volt coil and DPDT contacts. The relay in Figure A is shown in its normally open position. The output of the relay goes to a 110/115 volt receptacle that the charging power supply is plugged into. This device can be reconfigured to include vehicle or other data ports via the installation of a 5V, 12V, 24V or any other voltage rated relay necessary to power any cellular device. The relay coil is connected via a two conductor cable to a normally open switch that is attached through a nylon wire tie and two way tape, but can be connected in many different ways including but not limited to, split loom, two sided tape/nylon wire tie/Velcro, or any chemical bonding agent, to the cellular device charging plug at the cellular device end.

When disconnected from the cellular device, the switch will automatically open, thereby, releasing the relay and dropping all current draw from any given, charging power supply.

Figure B: Is a schematic drawing of the entire system as a single piece, factory integrated configuration. In this configuration, the relay is integrated into the cellular device charging power supply. The relay has an 110 VAC coil and DPDT contacts. The device can be reconfigured to include all other power and data ports utilized to provide power to cellular devices. The relay in figure B is shown in the normally open position. The input to the relay is directed off of the 110/125 VAC voltage contacts, but can be adapted to differing electrical loads as necessary. The output of the relay then goes to the charging circuit of the power supply. The coil of the relay is connected via a two conductor cable to a normally open switch attached as part of the singular end piece cellular device charging plug.

When disconnected from the cellular device, the switch will automatically open. Thereby, releasing the relay and dropping all current draw from any given, power supply port.

### DESCRIPTION OF THE PREFERRED EMBODIMENT

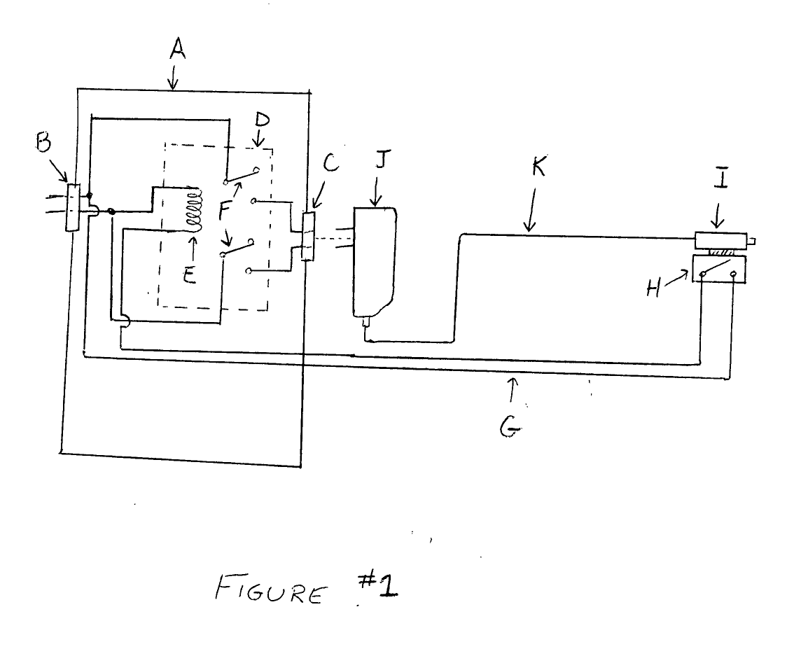

FIG. 1: is comprised of a standard plastic case (1), with a polarized, 120 VAC male plug (2) and a 120 VAC female receptacle (3). Within the plastic case is contained a relay (4). This relay has a 110 VAC coil (5) and DPDT contacts (6) rated at 3 amps/125 VAC, though ratings, as determined by a nationally recognized testing laboratory, would be acceptable as determined by load. This device has a two conductor cable (7) exiting through the side of the plastic case and extending to the activation switch (8) connected to the cellular device “plug-in” end of the cellular device charging cable.

When the cellular device charging plug is connected to the cellular device, the activation switch is closed, causing the relay to also close, thereby allowing the charging circuit to connect to the power source. The power supply is then activated, supplying charging voltage to the cellular device through the cellular device charging cable and cellular device charging plug.

When the cellular device charging plug is disconnected from the cellular device, the activation switch is opened, releasing power from the relay coil, deactivating the relay. Both the hot and neutral of the power source are then completely disconnected from the cellular device power supply, thereby allowing no current to be drawn from the source of power.

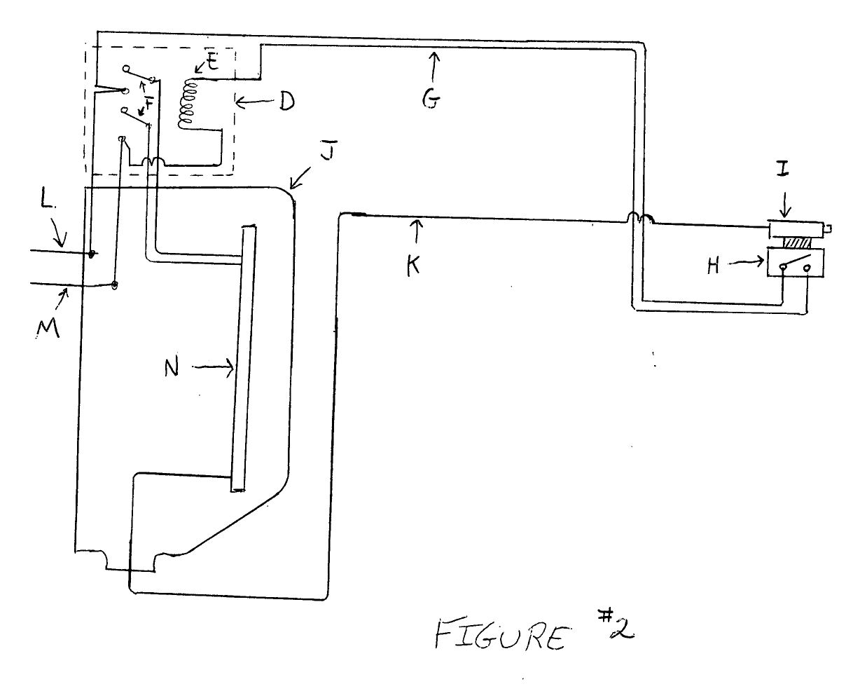

FIG. 2: Is comprised of a standard cellular charging device provided at point of sale that has been built (9) to include an integrated relay (10). The relay has an 110 VAC coil (11) and DPDT contacts (12) rated at 3 amps, 125 VAC, though ratings, as determined by a nationally recognized testing laboratory, would be acceptable as determined by electrical load. This device has a two conductor cable (13) exiting the power supply and extending to the activation switch (14) connected to the cellular device “plug-in” end of the cellular device charging cable.

When the cellular device charging “plug” is connected to the cellular device, the activation switch is closed, causing the relay to also close, thereby allowing the charging circuit to connect to the power source. The power supply is then activated, supplying charging voltage to the cellular device through the cellular device charging cable and cellular device charging plug.

When the cellular device charging plug is disconnected from the cellular device, the activation switch is opened, releasing power from the relay coil, deactivating the relay. Both the hot and neutral of the power source are then completely disconnected from the cellular device power supply, thereby allowing no current to be drawn from the source of power.

### FIG. 1:

A.) Housing, non-metallic
B.) Fixed 120 VAC male connector
C.) Fixed 120 female connector
D.) Relay with DPDT contacts and 120 VAC coil
E.) 120 VAC coil
F.) DPDT contacts
G.) Two conductor control cable attached to the cellular device charging cable
H.) Normally open switch attached to the cellular device charging plug at device end
I.) Cellular device charging plug
J.) Cellular device power supply
K.) Cellular device charging cable

### FIG. 2:

A.) (not used in FIG. 2)
B.) (not used in FIG. 2)
C.) (not used in FIG. 2)
D.) Relay with DPDT contacts and 120 VAC coil
E.) 120 VAC coil
F.) DPDT contacts
G.) Two conductor control cable attached to the cellular device charging cable
H.) Normally open switch attached to the cellular device charging plug at device end
I.) Cellular device charging plug
J.) Cellular device power supply
K.) Cellular device charging cable
L.) Fixed 120 VAC male connector, hot
M.) Fixed 120 VAC male connector, neutral
N.) Charging unit board

What is claimed is:

1. A power supply interrupter as an “after market” or secondary attachment connected to a power supply for a cellular device comprising:
A.) A standard plastic case with a polarized 120 VAC male plug AND a 120 VAC female receptacle.
B.) With in the plastic case is contained a relay with a 110 VAC coil and DPDT contacts rated at 3 amps/125 VAC.
C.) Many other ratings, as determined by a nationally recognized laboratory, would be acceptable as determined by electrical load.
D.) This device has a two conductor cable exiting through the side of the plastic case and extending to the activation switch connected to the cellular device charging point.
E.) This device can be connected to any existing power supply via Velcro, two way tape, split loom, insulating jacket, nylon wire tie or any other chemical bonding agent.
F.) The device in claim ‘A’ does stop all current draw from any given power supply [port] when not physically plugged into the cellular device charging point.
G.) Power for the power supply cut-off switch and activation switch will be supplied from the same power source as the cellular device power supply.

2. A factory integrated, power supply interrupter device comprising:
A.) A relay with a 110 VAC coil and DPDT contacts rated at 3 amps/125 VAC.
B.) Many other ratings, as determined by a nationally recognized laboratory, would be acceptable, as determined by electrical load.
C.) This device has a two conductor cable that extends from the relay to the activation switch connected to the cellular device charging point.
D.) This device is a single piece, factory made unit.
E.) The device in claim ‘B’ does interrupt all current draw from any given power supply [port] when not plugged into the cellular device charging point.
F.) In this configuration the relay is integrated into the computing device charging power supply or in a separate containment unit in the power supply source line.
G.) The input to the relay is directed off of the 110/115 VAC or other voltage contacts as dictated above.
H.) The output of the relay then goes to the charging circuit of the power supply [port].
